(19) United States
(12) Patent Application Publication
(10) Pub. No.: US 2025/0065522 A1
(43) Pub. Date: Feb. 27, 2025

(54) DEVICE FOR COMMINUTING FRUITS, AND METHOD FOR USING SAME

(71) Applicant: BOERNER DISTRIBUTION INTERNATIONAL GMBH, Landscheid-Niederkail (DE)

(72) Inventors: Alexandros POUSAIOS, Thessaloniki (GR); Pavlos AVANIDOS, Landscheid-Niederkail (DE); Wolfgang ELSEN, Speicher (DE); Thomas LICHTER, Welschbillig (DE)

(21) Appl. No.: 18/573,487

(22) PCT Filed: Jun. 29, 2022
(86) PCT No.: PCT/EP2022/067840

§ 371 Date: Jun. 28, 2024

(30) Foreign Application Priority Data
Jul. 1, 2021 (DE) 10 2021 117 040.0

(51) Int. Cl. B26D 1/04; B26D 3/30; B26D 7/01

(52) U.S. Cl. CPC B26D 1/04; B26D 3/30; B26D 7/01; B26D 2210/02

(57) ABSTRACT

Device (10) for comminuting fruits, having a base part (12) which has a platform (40), projecting in relation to a base bottom portion (16), for at last one fruit, and having a comminution part (14) which has at least one knife (34) and is movable so as to be guided relative to the base part (12) in such a manner that a fruit located on the platform (40) is comminuted by means of the knife (34), the platform (40) containing at least one slot (42) which extends from an upper side of the platform (40) in the direction toward the base bottom portion (16) and into which the knife (34) plunges during the guided movement. The base part (12) herein has a linear guide portion (18) on which the comminution part (14) can be moved so as to be linearly guided in a first direction (R1). (FIG. 2)

### CROSS-REFERENCE TO RELATED APPLICATIONS

The present application is a national phase entry under 35 USC § 371 of International Application PCT/EP2022/067840 filed Jun. 29, 2022, claiming priority to and benefit of German Patent Application No. 10 2021 117 040.0 filed Jul. 1, 2021, the entire disclosure of which is incorporated herein by reference.

### FIELD

The present disclosure relates to a device for comminuting fruits, having a base part which has a platform, projecting in relation to a base bottom portion, for at least one fruit, and having a comminution part which has at least one knife and is movable so as to be guided relative to the base part in such a manner that a fruit located on the platform is comminuted by means of the knife, the platform containing at least one slot which extends in the direction toward the base bottom part and into which the knife plunges during the guided movement.

The present disclosure furthermore relates to a method for comminuting fruits such as fresh fruit or vegetables by means of such a comminution device.

### BACKGROUND

In order to comminute fruit such as fresh fruit or vegetables, or else harder fruits such as nuts, it is known to comminute or chop the fruit on a chopping board by means of a knife.

Furthermore known are so-called vegetable slicers in which the fruit is guided along a guide face toward a knife in such a way that a slice is severed from the fruit.

Furthermore known are so-called egg slicers which have a hollow which is provided with slots and into which an egg can be placed. Furthermore, a handle having a multiplicity of wires is pivotably articulated on the base part of the egg slicer, said handle being able to be moved toward the egg, and the wires of the handle being able to be moved into the slots in the base, in such a way that the egg is sliced.

Furthermore known are chopping devices in which vegetables are comminuted by rotationally driven chopping blades.

The comminution devices mentioned above are either relatively complicated in terms of production, or relatively awkward in terms of handling and/or cleaning.

### SUMMARY

Against this background, it is an object of the disclosure to specify an improved comminution device for fruits and an associated method.

According to a first aspect of the present disclosure, the above object is achieved by a comminution device of the type mentioned at the outset, the base part having a linear guide portion on which the comminution part can be moved so as to be linearly guided in a first direction.

As a result of the comminution part and the base part being designed in such a manner that these can be guided relative to one another in a linear movement in order to carry out a comminution procedure, the base part and the comminution part can be produced in a cost-effective manner, for example from plastics material by an injection-molding method of a particularly simple type, in which the mold preferably does not contain any transversely movable elements.

Furthermore, the comminution device is easy to clean.

According to a particularly preferred embodiment, the base part has a first and a second guide post on which is configured in each case one guide face of the linear guide portion.

As a result, the linear guide portion can be implemented in a simple manner in terms of construction. The posts are preferably shaped in such a way that the comminution part can be guided thereon so that said comminution part is also guided so as to be secured against tilting during the linear movement. Furthermore, the guide posts can be configured as hollow posts so that production can be simple in terms of the injection-molding process.

It is particularly preferable here for the first and the second guide posts to be mutually spaced apart in a second direction, the second direction being aligned transversely to the first direction, preferably perpendicularly to the latter.

Positive linear guiding of the comminution part is possible as a result.

It is particularly preferable here for the platform in the second direction to be disposed between the first and the second guide posts.

According to a further preferred embodiment, the knife of the comminution part extends in the second direction. Alternatively or additionally, the slot of the platform extends in the second direction.

Since the comminution part can be moved linearly in a stable manner by means of the guide posts, a stable vertical movement of the knife can be established as a result, the latter during the comminution procedure plunging into the slot aligned in the same direction.

Consequently, the platform can also be configured so as to avoid that the fruit is squeezed into said platform during the comminution procedure.

It is furthermore advantageous for the comminution part to have a longitudinal extent in the second direction, which is perpendicular to the first direction, the comminution part having a transverse extent, which is smaller than the longitudinal extent, in a third direction which is perpendicular to the first direction and the second direction.

In other words, when viewed from above, the comminution part is configured to be approximately rectangular or oval. The knife preferably extends parallel to the long side of this rectangle, or of the oval, respectively. Consequently, comparatively large fruits can be comminuted.

It is particularly advantageous here for a spacing of the first and the second guide post of the base part to be greater than, or equal to, the transverse extent of the comminution part.

It can be achieved as a result that the comminution part in many embodiments can also be moved toward the platform when offset by 90°.

According to a particularly preferred embodiment, which in conjunction with the preamble of claim 1 represents an independent variant, the base part and the comminution part are mutually separate parts.

In contrast to an egg slicer of the type described above, for example, the base part and the comminution part are not fixedly articulated on one another. Handling is simplified as a result. Cleaning may also be facilitated as a result.

According to a further preferred embodiment, which in conjunction with the preamble of claim 1 represents an independent variant, the comminution part has a container portion with an elastically expandable container bottom portion which can expand during the guided movement so as to transfer at least part of the comminuted fruit into the container portion.

An expandable container bottom portion is presently understood to mean that the container bottom portion can be elastically deformed during the comminution procedure, so that the fruit located on the platform is not substantially crushed or otherwise damaged by the container bottom portion. On the other hand, the container bottom portion expands when the latter is guided across the fruit until said container bottom portion preferably lies below a contact face of the platform at the end of the comminution procedure. In other words, in the terminal position of the guided linear movement the container bottom portion lies below the fruit, and the container bottom portion has elastically regained its initial shape. When the comminution part is pulled back from the base part, the upper side of the container bottom portion consequently engages from below on the comminuted fruit and entrains the latter in such a manner that the comminuted fruit remains in the container interior of the container portion of the comminution part. The entrainment of the comminuted fruit when pulling the comminution part away from the base part is possible because the comminuted fruit can be moved upward without resistance, away from the contact face of the platform.

Consequently, the elasticity of the elastically expandable container bottom portion is preferably chosen to be so great that the container bottom portion expands during the comminution movement across the fruit, and subsequently returns to an initial position again. In the opposite pulling-away movement, the elasticity of the container bottom portion is so minor that the fruit located on the platform is entrained by the container bottom portion without the container bottom portion again being elastically expanded in the process.

Consequently, the container bottom portion acts in the manner of a “trap” for the comminuted fruit.

The embodiment according to which the base part and the comminution part are mutually separate parts forms a second aspect of the present disclosure.

The embodiment according to which the comminution part has a container portion with an elastically expandable container bottom portion forms a third aspect of the present disclosure.

The three aspects of the present disclosure can be arbitrarily combined with one another.

In the third aspect of the present disclosure it is preferable for the expandable container bottom portion to have a plurality of elastically deformable bottom segments which project in each case from a periphery of the container portion radially inward in terms of the first direction, the bottom segments preferably defining a central opening, the size of the latter corresponding to that of the platform when viewed from above in the first direction.

In this embodiment, the bottom segments are in each case configured in the manner of cantilever arms emanating from the periphery of the container bottom in the region of the lower end of the latter, and are in each case elastically deflectable or deformable in the manner of a cantilever arm, or of a tongue.

On account of the measure that the bottom segments define a central opening which corresponds to the platform, the bottom segments, specifically by virtue of their elasticity, can in any case return back to a basic position when said bottom segments have passed the upper contact face of the platform during the comminution procedure. The basic position is preferably a position in which the bottom segments are aligned substantially perpendicularly to the first direction.

According to a further preferred embodiment of the third aspect, the knife is disposed in a container interior of the container portion.

The knife herein is preferably disposed in such a way that a cutting edge of the knife is spaced apart from the container bottom portion.

The knife of the present disclosure can be a blade-type knife which has a specific extent in the first direction and, on the side pointing toward the container bottom portion, has a cutting edge. Presently however, the term “knife” is intended to have broad meaning. The knife can also be a cutting wire. The knife herein can extend in a linear direction, preferably along the second direction. However, the knife may also be serrated or have any other shape.

Furthermore, in many embodiments the knife can be configured as a cruciform knife which has a knife portion which extends in the second direction, and a knife portion which extends in the third direction, transversely to the second direction. In this design embodiment, a fruit located on the platform can be comminuted into more than two parts during a comminution procedure.

In the configuration of the knife as a cruciform knife it is preferable for the platform to have a second slot which is aligned so as to be parallel to the second knife.

Furthermore, it is particularly preferable for the platform to have two lateral clearances that lie opposite one another in a third direction which is aligned transversely to the first direction and a second direction.

The two lateral clearances are preferably connected by way of the slot.

When viewed from above, the two lateral clearances are preferably configured to be triangular, or conjointly configured in the shape of a hourglass when viewed from above.

It is particularly preferable herein for a container bottom portion of the comminution part to have two bottom segments which lie radially opposite one another and during the guided linear movement plunge into the clearances and are elastically deformable.

The two bottom segments which are assigned to the lateral clearances reach almost as far as the slot in the radial direction here, so that said bottom segments almost touch one another in the center, i.e. at a central axis of the platform. It can be guaranteed as a result that these bottom segments after radial expansion during the comminution procedure on the fruit are deformed in reverse back into the lateral clearances. It can therefore be guaranteed by these two bottom segments that even comparatively small fruits, which are not larger than the platform when viewed from above, are reliably entrained and remain in the container interior of the container portion of the comminution part during the pulling-away moving of the comminution part.

As has been mentioned at the outset, it is preferable for the base part and/or a container portion of the comminution part to be produced from plastics material.

The knife is preferably produced from a metal.

The bottom segments of the expandable container bottom portion are preferably produced from an elastic plastics material.

In many cases, the comminution part can therefore be produced as a bi-component injection-molded part, the container portion being of a relatively hard plastics material and the container bottom portion being of a relatively soft plastics material. The knife herein can be disposed as an “insert” in the mold. For this purpose, the knife on its ends in the first direction preferably has anchoring elements which guarantee reliable positioning of the knife within the comminution part when the latter is being injection molded.

It goes without saying that the features mentioned above and yet to be explained hereunder can be used not only in the respective stated combination but also in other combinations or individually, without departing from the scope of the present disclosure.

### BRIEF DESCRIPTION OF THE DRAWING VIEWS

Exemplary embodiments of the disclosure are illustrated in the drawing and will be explained in more detail in the description hereunder. In the drawing:

FIG. 1 shows a perspective view of an embodiment of a comminution device of the present disclosure;

FIG. 2 shows a sectional view along a line II-II of FIG. 1;

FIG. 3 shows a perspective view of the comminution part of the comminution device of FIGS. 1 and 2 viewed obliquely from below;

FIG. 4 shows a perspective view of the base part of the comminution device of FIGS. 1 and 2; and

FIG. 5 shows a view from above of the comminution part of the comminution device of FIGS. 1 and 2.

### DETAILED DESCRIPTION

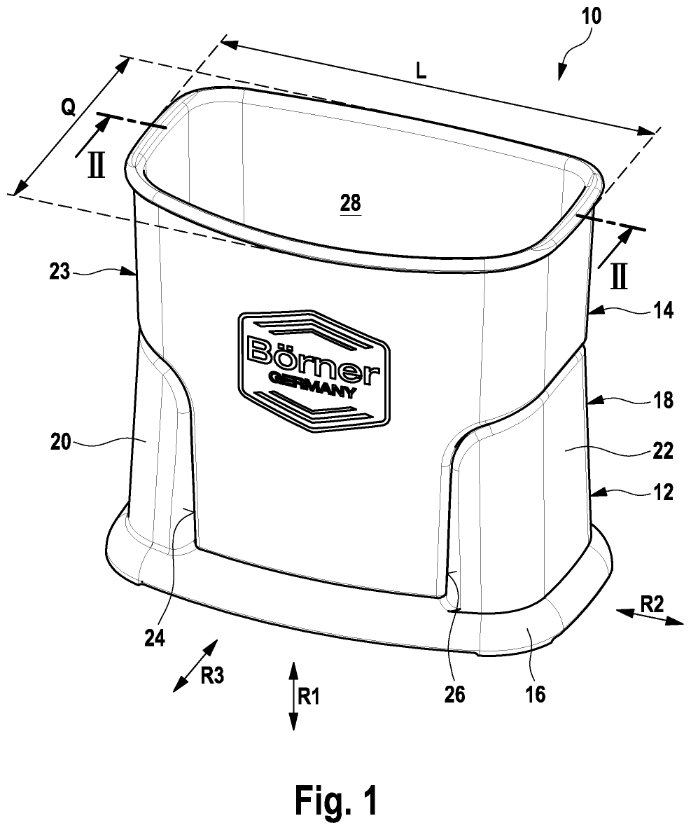

A comminution device 10 for fruits according to one embodiment is illustrated in FIGS. 1 to 5.

The comminution device 10 serves for comminuting fruits such as fresh fruit or vegetables, in particular, for example, tomatoes, berries, small apples, or the like.

The comminution device 10 has a base part 12 and a comminution part 14 configured separately from said base part 12.

As is illustrated in FIGS. 1, 2 and 4, the base part 12 has a base bottom portion 16 so that the base part 12 can be set down on a worktop. Furthermore, the base part 12 has a linear guide portion 18 by means of which the comminution part 14 can be moved relative to the base part 12 so as to be guided along a linear movement in a first direction R1.

The linear guide portion 18 is presently formed by a first guide post 20 and a second guide post 22 which along the first direction R1 project upward in relation to the base bottom portion 16.

The comminution part 14 has a container portion 23 on which are configured a first guide clearance 24 and a second guide clearance 26, the shape of said guide clearances 24, 26 being adapted to the guide posts 20, 22. The container portion defines a container interior 28 which is configured to received comminuted fruits. The container interior 28 is configured to be open in the first direction R1 toward the top. At the upper end, the comminution part 14 defines an upper periphery which borders the container interior 28, specifically at the upper end of the comminution part 14.

The base bottom portion 16 likewise defines an outer periphery 32. The shape of the outer periphery 32 and the shape of the upper periphery 30 are approximately identical, the dimensions of the upper periphery 30 being somewhat smaller than those of the outer periphery 32.

The comminution part 14 and the base part 12 are configured in such a way that, when the comminution part is inserted in the base part 12 as shown in FIG. 1, an external wall of the comminution part 12 is aligned so as to be flush with external walls of the guide posts 20, 22, so that a harmonious appearance is provided.

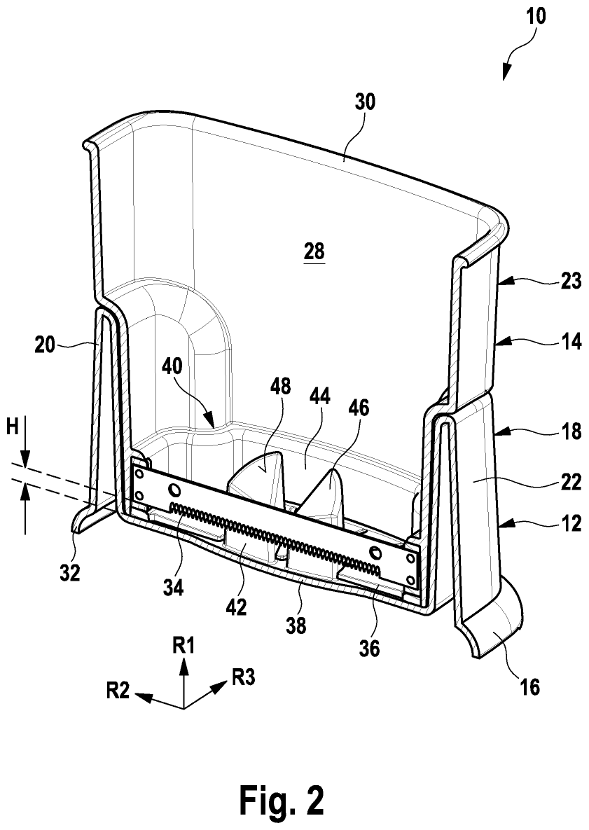

The guide posts 20, 22 are configured as hollow posts, as can be seen in particular in FIG. 2, the shape of the posts tapering conically upward in the first direction R1 so that the posts can be easily implemented in terms of the injection-molding process.

The comminution part 14 furthermore has a knife 34. The knife 34 is disposed in the container interior 28, specifically above a container bottom portion 36 of the comminution part 14. The container bottom portion 36 of the comminution part 14 defines a lower end of the comminution part 14 in the first direction R1, which lies opposite the upper periphery 30.

The comminution device 10, specifically, in particular, the comminution part 14 thereof, has a longitudinal extent L in a second direction R2 which is perpendicular to the first direction R1. Furthermore, the comminution device 10, in particular the comminution part 14 thereof, has a transverse extent Q in a third direction R3 which is perpendicular to the first direction R1 as well as the second direction R2. Q is smaller than L.

As is shown in FIG. 2, the knife 34 extends in the second direction R2 within the container interior 28.

A cutting edge of the knife 34, which points in the first direction R1 toward the container bottom portion 36, is spaced apart from the container bottom portion 36 by a height H which is greater than 0 mm and preferably smaller than 15 mm, without being limited thereto.

The longitudinal extent L can be in the range from 8 cm to 15 cm, for example, without being limited thereto. The transverse extent Q can be in a range from 4 cm to 10 cm, without being limited thereto.

The height in the first direction R1 of the comminution part 14 can be in a range from 7 cm to 13 cm, without being limited thereto.

The base part 12 has a base bottom 38 between the guide posts 20, 22, the guide posts 20, 22 projecting upward in the first direction R1 in relation to said base bottom 38.

Furthermore, the base part 12 has a platform 40 which in the second direction R2 is disposed between the guide posts 20, 22. The platform 40, proceeding from the base bottom, extends upward in the first direction R1, specifically so as to be substantially parallel to the guide posts 20, 22.

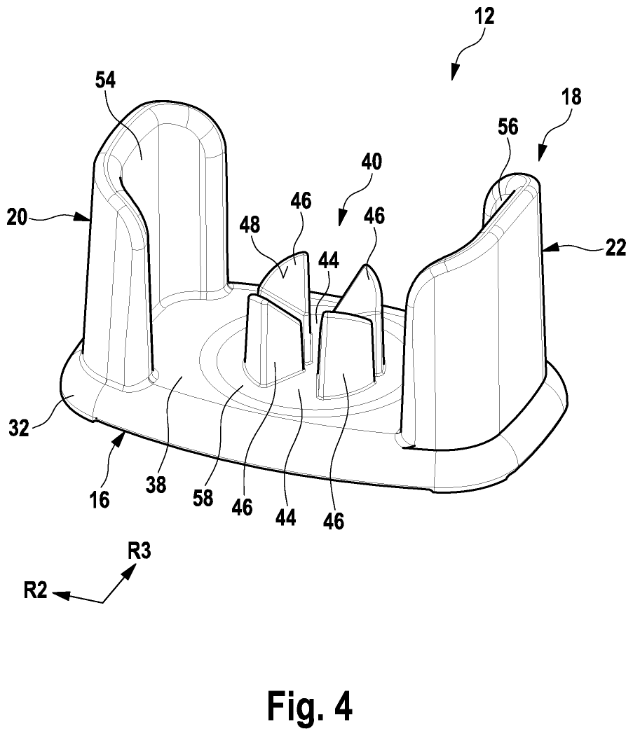

As is shown in FIGS. 2 and 4, the platform 40 has a slot 42 which extends in the second direction R2 and is configured to receive the knife 34.

In other words, in a comminution procedure, in which the comminution part 14 is moved in the first direction R1 toward the base bottom 38, the knife 34 plunges into the slot 42.

The slot 42 preferably extends all the way down to the base bottom 38.

The platform 40 furthermore has two lateral clearances 44 which lie opposite one another in the third direction R3. When viewed from above in the first direction R1, the lateral clearances 44 are in each case configured to be approximately triangular, the tips of the triangles pointing toward the slot 42. When viewed from above, the two lateral clearances 44 collectively have the approximate shape of an hourglass.

The lateral clearances 44 likewise extend in the first direction R1 all the way down to the base bottom 38.

As a result, the platform 40 is formed by four individual platforms 46 which are in each case delimited by part of the slot 42 and one of the lateral clearances 44, specifically when viewed in the circumferential direction. When viewed from above, the individual platforms 46 have in each case approximately the shape of a sector of a circle extending across an angular range of less than 90°.

The individual platforms 46, on the upper side of the individual platforms 46 in the first direction R1, have in each case one contact face 48 which, proceeding from an external circumferential portion of the respective individual platform 46, descends in the first direction R1 toward an intersection point between the slot 42 and the clearances 44.

Consequently, the contact faces 48 of the four individual platforms 46 conjointly form a type of hollow for a fruit placed on the platform 40.

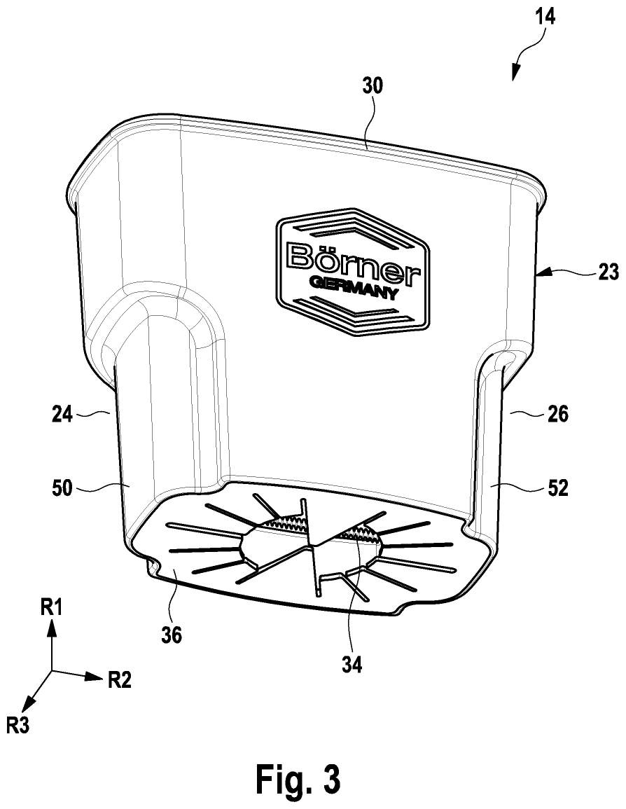

As is shown in particular in FIGS. 3 and 4, the comminution part 14 in the region of the first guide clearance 24 has a first guide face 50, and in the region of the second guide clearance 26 a second guide face 52.

The guide faces 50, 52 are in each case configured symmetrically in terms of the second direction R2, and define in each case an approximately semicircular shape.

On the other hand, as is shown in particular in FIG. 4, the guide posts 20, 22 on the radial inner sides thereof have a first guide face 54, or a second guide face 56, respectively, which point toward one another in the second direction R2. The guide faces 54, 56 are adapted to the guide faces 50, 52 and are likewise configured to be approximately semicircular, or elongate with lateral guide tabs.

Consequently, the comminution part 14 can be guided in the first direction R1 on the base part 12 so as to be secured against tilting. It is guaranteed as a result that the knife 34 is always aligned with the first direction R1 during the linear guide movement.

The base bottom 38 has a central depression 58 about the platform 40. If fruit juice leaks from the fruit during the comminution procedure, this fruit juice is substantially collected in the central depression 58.

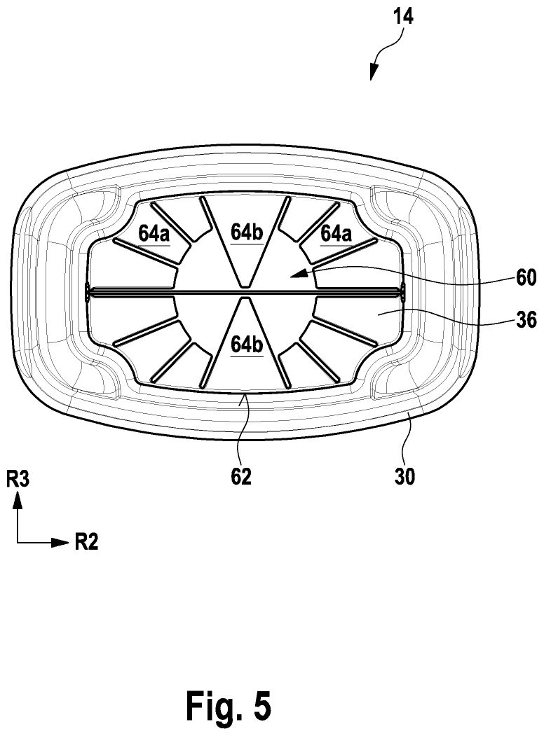

As is shown in FIG. 5, the container bottom portion 36 has a central opening 60, the shape of the latter being adapted to the shape of the platform 40 when viewed from above. When viewed from above, the central opening 60 defines two sectors of a circle, which are in each case assigned to two individual platforms 46 lying opposite the knife 34. If the comminution part 14 is completely inserted in the base part 12 in such way that the container bottom portion 36 bears on the base bottom 38, the individual platforms 46 plunge into the central opening 60.

More specifically, the container bottom portion 36 is defined by a multiplicity of bottom segments 64 which, proceeding from a lower inner periphery 62 of the container portion 23 of the comminution part 14, extend radially inward.

The bottom segments 64 contain such bottom segments 64a that extend to an outline (e.g. contour circle) of the platform 40. Furthermore, the bottom segments 64 contain two bottom segments 64b that extend into the lateral clearances 44. When viewed from above, the two bottom segments 64b are in each case approximately triangular, corresponding to the shape of the lateral clearances 44. The two bottom segments 64a plunge completely into the lateral clearances 44. The knife 34 is disposed between the tips of the two bottom segments 64b.

The comminution device 10 is used as follows:

First, the comminution part 14 is removed from the base part 12.

A fruit is subsequently placed onto the platform 40 of the base part 12. The comminution part 14 is subsequently attached to the base part 12, and the comminution part 14 is moved so as to be guided on the linear guide portion 18 in the first direction R1 toward the base bottom 38. The fruit bearing on the platform 40 is initially contacted by at least the bottom segments 64b, the bottom segments 64 that contact the fruit being elastically deflected in the process. In the further course of the guided movement, the blade of the knife 34 impacts the upper side of the fruit and plunges into the fruit. The bottom segments 64a are deflected further in the process.

Finally, the knife 34 has completely severed the fruit on the platform 40 and plunges into the slot 42. Already beforehand, the deflected bottom segments 64 have elastically reset themselves and returned to the initial shape, the latter shown in FIG. 5. Consequently, at least the two bottom segments 64b lie partially below the comminuted fruit located on the platform 40.

The comminution part 14 is subsequently lifted from the base part 12. In the process, at least the two bottom segments 64b engage behind the comminuted fruit and lift the latter from the contact faces 48 of the platform 40. In other words, the comminuted fruit remains in the container interior 28 of the container portion 23 of the comminution part 14.

This procedure can be repeated without the pieces of fruit already contained in the container interior 28 having to be emptied out. Rather, a plurality of fruits can be comminuted in this manner until the pieces of a multiplicity of fruits, or fruit pieces, are located in the container interior 28.

In a last operative step, the comminution part 14 can be turned over so that the pieces of fruit contained in the container interior 28 can be tipped out in a targeted manner, specifically by way of the opening of the container interior 28 on the upper periphery 30. For example, a salad of fruit pieces can be prepared in such a way. Furthermore, fruit pieces for a muesli or a cake topping can be generated and subsequently filled into a muesli bowl or emptied onto a cake base. Overall, a number of applications are possible.

The comminution part 40 and the base part 12 can subsequently be cleaned in a simple manner, for example by rinsing under a water tap. If suitable plastics materials are used, the comminution part and the base part 12 can optionally also be placed in a dishwasher.

### LIST OF REFERENCE SIGNS

10 Comminution device
12 Base part
14 Comminution part
16 Base bottom portion
18 Linear guide portion
20 First guide post
22 Second guide post
23 Container portion
24 First guide clearance
26 Second guide clearance
28 Container interior
30 Upper periphery of 28
32 Outer periphery of 16
34 Knife
36 Container bottom portion
38 Base bottom
40 Platform
42 Slot
44 Lateral clearances
46 Individual platform
48 Contact face
50 First guide face of 14
52 Second guide face of 14
54 First guide face of 20
56 Second guide face of 22
58 Central depression in 38
60 Central opening of 36
62 Lower inner periphery of 23
64 Bottom segments
R1 First direction
R2 Second direction
R3 Third direction
L Longitudinal extent
Q Transverse extent
H Spacing between knife blade and bottom portion

1. A device (10) for comminuting fruits, having
a base part (12) which has a platform (40), projecting in relation to a base bottom portion (16), for at least one fruit, and
a comminution part (14) which has at least one knife (34) and is movable so as to be guided relative to the base part (12) in such a manner that a fruit located on the platform (40) is comminuted by means of the knife (34),
the platform (40) containing at least one slot (42) which extends from an upper side of the platform (40) in the direction toward the base bottom portion (16) and into which the knife (34) plunges during the guided movement,
wherein the base part (12) has a linear guide portion (18) on which the comminution part (14) can be moved so as to be linearly guided in a first direction (R1).

2. The comminution device as claimed in claim 1, the base part (12) having a first guide post (20) and a second guide post (22), the first guide post (20) having a first guide face (54) of the linear guide portion (18) and the second guide post (22) having a second guide face (56) of the linear guide portion (18).

3. The comminution device as claimed in claim 2, the first and the second guide posts (20, 22) being mutually spaced apart in a second direction (R2), the platform (40) in the second direction (R2) being disposed between the first and the second guide posts (20, 22).

4. The comminution device as claimed in claim 1, the knife (34) of the comminution part (14) extending in a second direction (R2) perpendicular to the first direction (R1), and the slot (42) of the platform (40) extending in the second direction (R2).

5. The comminution device as claimed in claim 1, the comminution part (14) having a longitudinal extent (L) in a second direction (R2) perpendicular to the first direction (R1), the comminution part (14) having a transverse extent (Q) in a third direction (R3) perpendicular to the first direction (R1) and the second direction (R2), wherein the transverse extent (Q) of the comminution part (14) is less that the longitudinal extent (L) of the comminution part (14).

6. The comminution device as claimed in claim 5, a spacing of a first and a second guide post (20, 22) of the base part (12) being greater than, or equal to, the transverse extent (Q) of the comminution part (14).

7. The comminution device as claimed in claim 1, the base part (12) and the comminution part (14) being mutually separate parts.

8. The comminution device as claimed in claim 1, the comminution part (14) having a container portion (23) with having an elastically expandable container bottom portion 36) which can expand during the guided movement of the comminution part (14) relative to the base part (12) so as to transfer at least part of the comminuted fruit into the container portion.

9. The comminution device as claimed in claim 8, the expandable container bottom portion (36) having a plurality of elastically deformable bottom segments (64) which each project from a periphery (62) of the container portion (23) radially inward relative to the first direction (R1), the plurality of bottom segments (64) preferably defining a central opening (60), the size of the central opening (60) corresponding to that of the platform (40) when viewed from above in the first direction (R1).

10. The comminution device as claimed in claim 8, the knife (34) being disposed in a container interior (28) of the container portion (23).

11. The comminution device as claimed in claim 1, the platform (40) having two lateral clearances (44) that lie opposite one another in a third direction (R3) which is aligned transversely to the first direction (R1) and a second direction (R2).

12. The comminution device as claimed in claim 11, a container bottom portion (36) of the comminution part (14) having two bottom segments (64b) which lie radially opposite one another and during the guided linear movement plunge into the clearances (44).

13. The comminution device as claimed in claim 1, the base part (12) and/or a container portion (23) of the comminution part being produced from plastics material.

14. A method for comminuting fruits such as fresh fruit or vegetables by means of a comminution device (10) as claimed in claim 1, comprising the following steps:
removing the comminution part (14) from the base part (12);
placing a fruit onto the platform (40) of the base part (12); and
engaging the comminution part (14) with the base part (12) and guiding the comminution part (14) on the guide portion (18) of the base part (12) in the first direction (R1) in such a way that the knife (34) comminutes the fruit on the platform (40) and plunges into the slot (42) of the platform (40);
the comminuted fruit parts making their way via an elastically expandable container bottom portion (36) into a container interior (28) of a container portion (23) of the comminution part (14).

15. The method as claimed in claim 14, further comprising the following step:
lifting the comminution part (14) from the base part (12), the comminuted fruit parts being held in said container interior (28) after the comminution part (14) is lifted from the base part (12).

16. The comminution device as claimed in claim 11, wherein the two lateral clearances (44) are connected by way of the slot (42).

17. The comminution device as claimed in claim 13, wherein at least one of the base part (12) and the container portion (23) of the comminution part is produced as an injection-molded plastic part.

18. The method as claimed in claim 14, wherein the comminuted fruit parts make their way via the elastically expandable container bottom portion (36) into the container interior (28) of the container portion (23) of the comminution part (14) as the comminution part (14) is guided on the guide portion (18) of the base part (12) in the first direction (R1).
